(19) United States
(12) Patent Application Publication
(10) Pub. No.: US 2016/0294743 A1
(43) Pub. Date: Oct. 6, 2016

(54) BROWSER TOOLBAR

(71) Applicant: David Davies, Redwood City, CA (US)

(72) Inventor: David Davies, Redwood City, CA (US)

(21) Appl. No.: 14/673,727

(22) Filed: Mar. 30, 2015

(51) Int. Cl. H04L 12/58; H04L 29/06; G06F 3/0482; G07C 13/00; G06Q 20/10; G06Q 20/36; G06Q 20/22; H04L 29/08; G06Q 20/40

(52) U.S. Cl. CPC H04L 51/046; H04L 67/02; H04L 63/08; G06F 3/0482; G06Q 20/405; G06Q 20/10; G06Q 20/36; G06Q 20/223; G07C 13/00

(57) ABSTRACT

A method for enabling two or more users to chat within a toolbar for a web browser is disclosed, having the steps of authenticating a user ID of an individual, authenticating the user IDs of one or more other users, the user navigating to a webpage, displaying user IDs of one or more other users currently on the same webpage on the toolbar, the individual typing a comment, wherein the comment is linked to the webpage, the toolbar verifying the comment and communicating the comment to one or more other users, and the toolbar displaying comments from other users to the individual. The comment may include a vote configured to upvote or downvote the webpage. The vote or comment may be linked to a particular user ID. The method may have the further step of the individual voting on the webpage.

### CROSS-REFERENCE TO RELATED APPLICATION

Not Applicable.

### BACKGROUND OF THE INVENTION

1. Field of Invention

This invention relates to a web browser toolbar add-on.

2. Description of Related Art

For many years in the Internet, the notions of comments and user votes have been popular. Comments can be shared with others to provide views on a product or service. Websites and other communications are ranked this way, by upvoting or downvoting using “Likes” and other similar means, whereby users click the Like button to add a vote for the idea, product or service. The votes are tied with a user's identity and in addition to the user's voting bettering a site's ranking, the user's votes can be seen by, and shared with, friends or associates.

However, voting that is tied with a unique identify has not been available outside of social media, and voting on sites or content has, for the most part, been anonymous or associated with a website specific id or login. There is no third-party tool that carries a users identity between websites to permit interaction with other users of the tool on a specific website.

In addition, there is no facility for transmitting value (crypto-coins, for example) between users of such a tool and on a specific website, so as to facilitate transfer for items on a website, with the website itself or between users, in the case of forums and marketplaces, for example.

Therefore there is a need for a browser add-on which permits sharing of comments or voting on websites without a required connection with a social media site.

### SUMMARY OF THE INVENTION

A method for enabling two or more users to chat within a toolbar for a web browser is disclosed, having the steps of authenticating a user ID of an individual, authenticating the user IDs of one or more other users, the user navigating to a webpage, displaying user IDs of one or more other users currently on the same webpage on the toolbar, the individual typing a comment, wherein the comment is linked to the webpage, the toolbar verifying the comment and communicating the comment to one or more other users, and the toolbar displaying comments from other users to the individual.

The comment may include a vote configured to upvote or downvote the webpage. The vote may be linked in a database to a particular user ID, and/or the comment is linked to a particular user ID.

The method may have the further step of the individual voting on the webpage. The vote may be tallied in the database and shared with the other users. The comments may be shared between a plurality of users. The method may have the additional step of terminating the chat when the individual leaves the webpage. It may also have the steps of the individual initiating currency transfer to at least one other user, the application creating a secure link with the e-wallet of the at least one other user, verifying account information and availability of funds, and transferring currency between the individual and the other user.

Also described is a method for enabling two or more users to exchange currency within a toolbar for a web browser, comprising the steps of authenticating a user ID of an individual, the individual navigating to a webpage, authenticating the user IDs of one or more other users, displaying user IDs of one or more other users currently on the same webpage on the toolbar, the user initiating currency transfer to another user, the application creating a secure link with the e-wallet of another users, verifying account information and availability of funds, and transferring currency between the individual and the other user.

The other user may be an entity controlling the webpage. It may have the further steps of the individual typing a comment, wherein the comment is linked to the webpage, the toolbar verifying the comment and communicating the comment to one or more other users, and the toolbar displaying comments from other users to the individual.

The comment may include a vote configured to upvote or downvote the webpage. The vote may be linked in a database to a particular user ID. The comment may be linked to a particular user ID. The method may have the additional step of the individual voting on the webpage.

The vote may be tallied in the database and shared with the other users. The comments may be shared between a plurality of users. The method may also have the further step of terminating the chat when the individual leaves the webpage.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 shows a data flow diagram for the browser add-on, according to one embodiment of the present invention;

FIG. 2 shows a continuation of the data flow diagram, including a method of transferring currency between users, according to an embodiment of the present invention;

FIG. 3 shows the toolbar app within a browser on a user's display; and

FIG. 4 shows a screenshot showing functionality of the toolbar app.

### DETAILED DESCRIPTION OF THE INVENTION

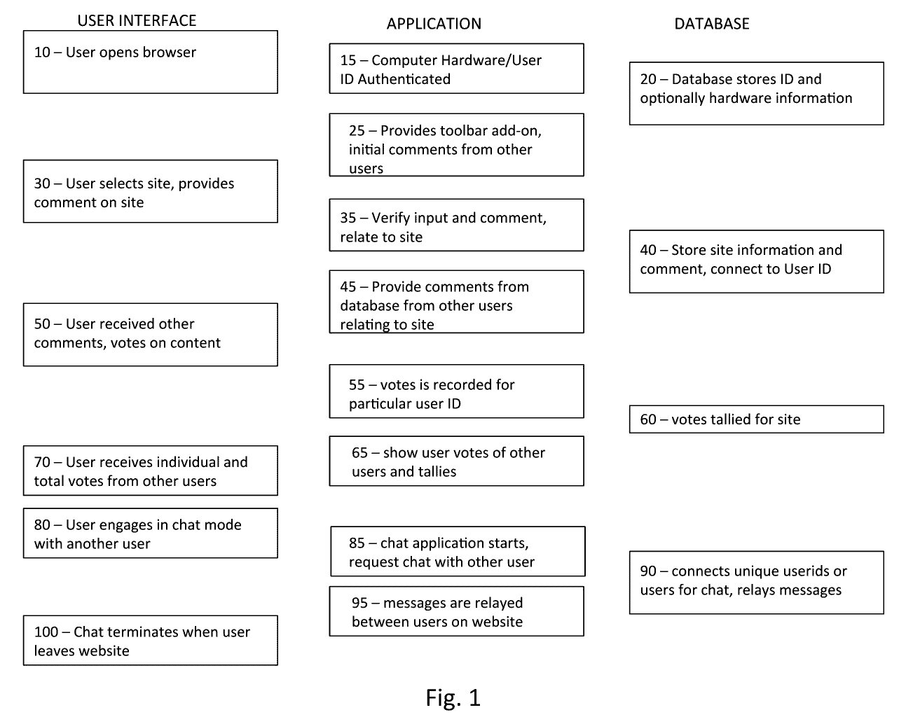

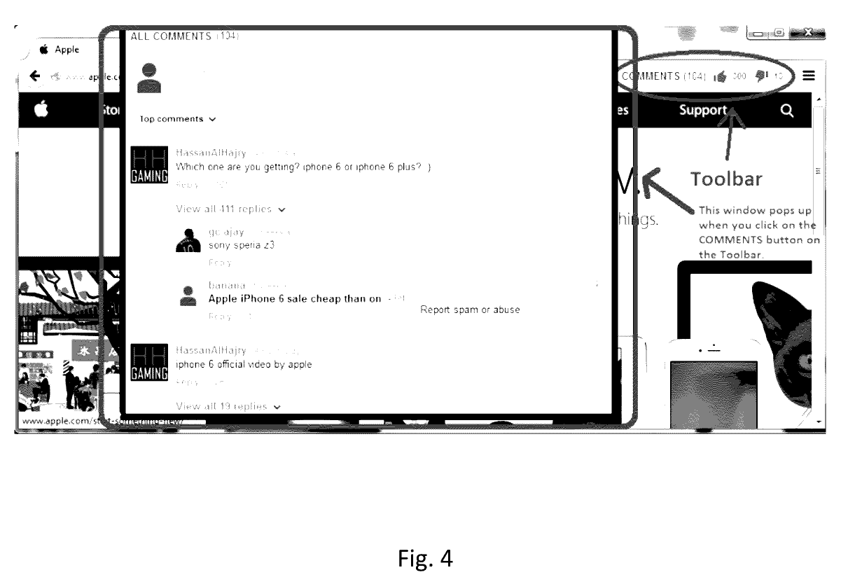

Preferred embodiments of the present invention and their advantages may be understood by referring to FIGS. 1-4) wherein like reference numerals refer to like elements.

The present invention, in an embodiment, is a toolbar on a browser. As an add-on, the toolbar sits on the face of the browser window and adds functionality to web browser programs such as Firefox, Internet Explorer, Safari and Chrome. In particular, the toolbar lets users post comments related to a website they are currently viewing. As an example, on a webpage related to pineapples, regardless of the content, the user can leave a comment saying “I like pineapples.” The comment can be shared with other users.

Once installed, the toolbar adds a COMMENTS button on the face of a browser. To leave a comment, the user goes to any webpage and clicks on the COMMENTS button that the toolbar has added to their browser. After the button is clicked, a window pops up showing existing comments from the current user as well as other users using the toolbar application. In addition, a text field is available, where new comments can be entered. Comments entered through another means on the website, without using the toolbar application, may be pulled from the website using an API, to be viewed and commented on in the toolbar, in one embodiment of the invention.

Once a comment is entered it is sent to a server where it is stored in a database and linked to a user's unique key. The unique key ensures each app user is unique and enables tracking of his comments and votes. At a minimum, the database has an entry for each webpage where a user has left a comment. Using the example above, a site about pineapples would have a data point with the comment “I like pineapples.” associated with the current user. Other users providing comments on that site would have their comments stored in a similar fashion, in relation to both the website and a unique user. Each comment is connected to a user's unique identifier within the database schema.

In an embodiment, each comment can be “upvoted” or “downvoted” by other users. An upvote increases the value of a comment, and a downvote decreases the value of a comment. In this embodiment, the number of upvotes and downvotes a comment receives is also stored in a database on a server along with that unique comment.

In an embodiment, in addition to allowing users to leave comments the toolbar also allows users to upvote and downvote any webpage. This upvote/downvote information is also stored on a server and linked with both the user and website, and may be displayed up any time a user visits a new website. Further, to cumulative upvoting or downvoting of the users may be displayed in relations to a website or websites, in order to provide rankings and other benefits to users. In an embodiment, the comments are displayed on the browser near the COMMENTS button, for those who have installed the toolbar.

In an embodiment, the toolbar has a chat button which enables a user on a given site to chat with another user on the site. The user may select the other user's UserID for a private chat or a chatroom may be created for multiple users to discuss the website. When a user leaves the website, he is immediately disconnected from that chat, such that the chatting users are all contextually linked by being on that website.

In one embodiment, the toolbar is complemented by a website portal where users can access the comments and voting systems provided by the Toolbar without actually having to install the Toolbar software. In an embodiment, the user enters the URL of the website they want to comment or vote on in a text field on the portal. The portal then displays the same data with regard to comments by users and upvoting or downvoting, with a similar level of information and functionality that would have been available if the user had pressed the COMMENTS button on the Toolbar.

With reference to FIG. 1, once installed, the browser add-on is present on the browser, no matter the site the user is viewing. In step 10, the user opens the browser and the browser add-on initializes. In an embodiment, the browser add-on has a User ID associated therewith, and in step 15 the User ID as well as any hardware identifying information is send to the database. In step 20, the database stores the hardware and identifying information, as well as the User ID. At step 25, the database provide information to populate the toolbar, including initial comments from other users regarding the home page. In step 30, the user selects a site using the browser, and inputs comments related to the site into the COMMENT window. The application verifies the input at claim 35 and relates it to the site. At step 40 the site address and the comment are stored and connected to the User ID. In step 45, the database provides comments from other users related to the site. The user receives the comments at step 50 through the toolbar, and votes on the content of the site. In step 55, the votes are recorded and connected to a particular User ID. In step 60 the votes are recorded in the database and tallied. In step 65, the toolbar returns the individual votes of other users and the tallies. In step 70, the user receives the individual votes and tallies through the toolbar.

In step 80, the user engages in a chat mode with another user. The toolbar presents a chat window wherein text may be entered and sent to the other unique user that the first user selected. In step 85, the toolbar initiates a chat request for the second user. The message and the user are relayed to the back-end in step 90, wherein the user is verified and the message stored in the database, to be sent to the second user. In step 95, messages are sent between users through the back-end. In step 100, the first user terminates the chat by moving to another website.

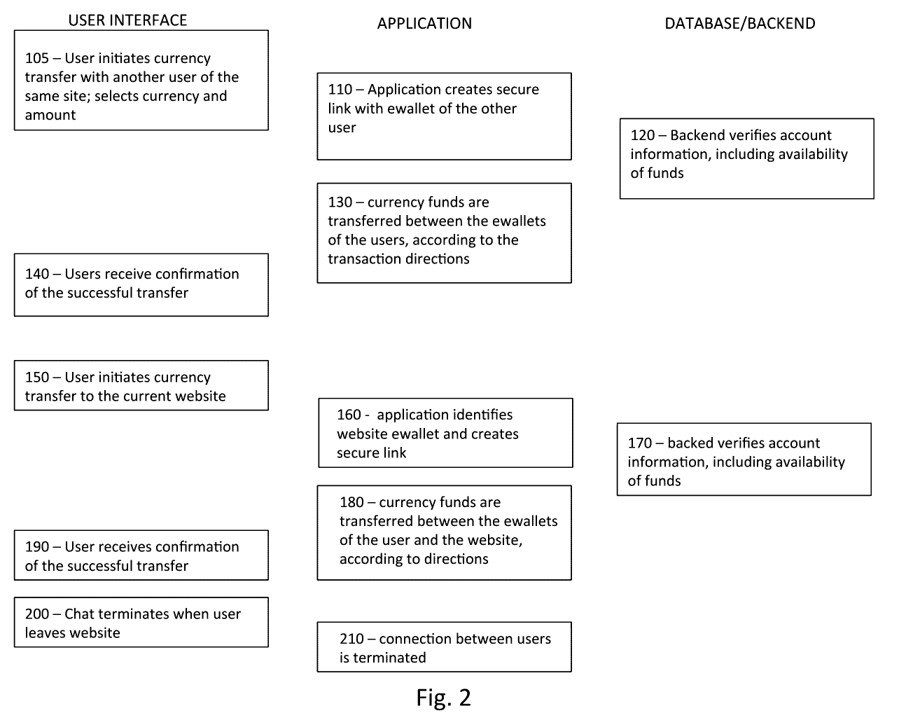

With reference to FIG. 2, currency, in particular crypto-currency such as Bitcoin, Kilocoin and Hempcoin, may be exchanged with other users and/or the website to pay for goods and services. In step 105, the user initiates currency transfer with another user of the same site, and selects currency and amount. In step 110, the application creates secure link with ewallet of the other user. In step 120 the backend verifies account information, including availability of funds, in the user's ewallet. The user receives a unique identification number once the toolbar is installed, and in one embodiment this identification number is a wallet ID. The toolbar can also be configured to send certain amounts of coins to each user upon successful installation of the toolbar. In step 130, currency funds are transferred between the ewallets of the users, according to the transaction directions, by the application. In step 140, the users receive confirmation of the successful transfer. In step 150, the user initiates the transfer of funds to the website rather than another user. In step 160, the application identifies website ewallet and creates a secure link. In step 170, the backed verifies account information, including availability of funds. In step 180, currency funds are transferred between the ewallets of the user and the website, according to directions of the transfer. In step 190, the user and the website receive confirmation of the successful transfer. In step 200, the user initiates a termination of the connection between the user and the website when the user leaves the website. In step 210, connection between users is terminated by the application.

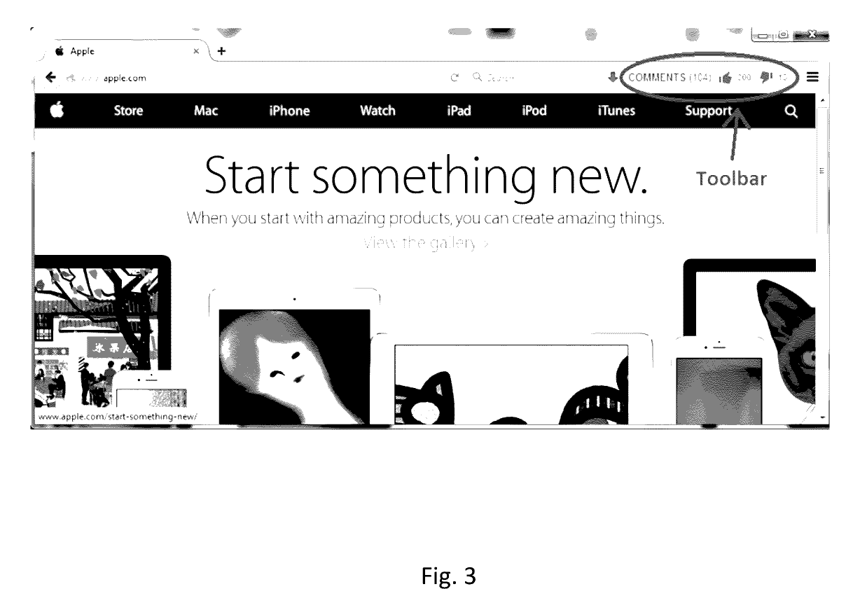

The browser add-on modifies the browser to add the comment toolbar to the browser, as shown in FIGS. 2 and 3. The comments and information related to the website are stored in a database on a server. The application may be built by JavaScript or another programming languages.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method for enabling two or more users to chat within a toolbar for a web browser, comprising the steps of:
a. authenticating a user ID of an individual;
b. authenticating the user IDs of one or more other users;
c. the individual navigating to a webpage;
d. displaying user IDs of one or more other users currently on the same webpage on the toolbar;
e. the individual typing a comment, wherein the comment is linked to the webpage;
f. the toolbar verifying the comment and communicating the comment to one or more other users; and
g. the toolbar displaying comments from other users to the individual.

2. The method of claim 1 wherein the comment includes a vote configured to upvote or downvote the webpage.

3. The method of claim 2 wherein the vote is linked in a database to a particular user ID.

4. The method of claim 1 wherein the comment is linked to a particular user ID.

5. The method of claim 1, further comprising the step of the individual voting on the webpage.

6. The method of claim 5, wherein the vote is tallied in the database and shared with the other users.

7. The method of claim 1, wherein the comments are shared between a plurality of users.

8. The method of claim 1, further comprising the step of terminating the chat when the individual leaves the webpage.

9. The method of claim 1, further comprising the steps of:
a. the individual initiating currency transfer to at least one other user;
b. the application creating a secure link with the e-wallet of the at least one other user;
c. verifying account information and availability of funds; and
d. transferring currency between the individual and the other user.

10. A method for enabling two or more users to exchange currency within a toolbar for a web browser, comprising the steps of:
a. authenticating a user ID of an individual;
b. the individual navigating to a webpage;
c. authenticating the user IDs of one or more other users;
d. displaying user IDs of one or more other users currently on the same webpage on the toolbar;
e. the individual initiating currency transfer to another user;
f. the application creating a secure link with the e-wallet of another users;
g. verifying account information and availability of funds; and
h. transferring currency between the individual and the other user.

11. The method of claim 10 wherein the other user is an entity controlling the webpage.

12. The method of claim 10 further comprising the steps of:
a. the individual typing a comment, wherein the comment is linked to the webpage;
b. the toolbar verifying the comment and communicating the comment to one or more other users; and
c. the toolbar displaying comments from other users to the individual.

13. The method of claim 12 wherein the comment includes a vote configured to upvote or downvote the webpage.

14. The method of claim 13 wherein the vote is linked in a database to a particular user ID.

15. The method of claim 12 wherein the comment is linked to a particular user ID.

16. The method of claim 12, further comprising the step of the individual voting on the webpage.

17. The method of claim 16, wherein the vote is tallied in the database and shared with the other users.

18. The method of claim 12, wherein the comments are shared between a plurality of users.

19. The method of claim 12, further comprising the step of terminating the chat when the individual leaves the webpage.
